(19) United States
(12) Patent Application Publication
(10) Pub. No.: US 2009/0140616 A1
(43) Pub. Date: Jun. 4, 2009

(54) TRASH COMPACTOR CABINET

(76) Inventor: Anthony Fox, Minneapolis, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/949,855

(22) Filed: Dec. 4, 2007

(51) Int. Cl. B30B 15/04; A47B 81/00

(52) U.S. Cl. 312/211

(57) ABSTRACT

The invention comprises a trash compactor cabinet formed from two panels of sheet metal. The panels are the same shape and are attached with one being inverted compared to the other along a V-shaped channel at one end of the panel. The panels have a V-shaped channel in the back side of the panel to form a passageway between shelves in the cabinet and the rear wall of the cabinet. A front portion of the panel is formed by a channel for attaching doors or door frames to the front of the cabinet. The cabinet can be formed by quickly and easily bending sheet metal into the panels and welding the panels together.

### BACKGROUND OF THE INVENTION

1. Field of the Invention

This invention relates to trash compactors and more particularly to cabinet construction for the trash compactor.

2. Description of the Related Art

Trash compactors generally have a plate which presses against trash in a container to reduce the volume of the trash therein such that trash disposal storage space is minimized. The forces in the trash compactor are such that the frame or housing must be strong enough to hold the machinery for compacting the trash and withstand the forces required for compaction.

It is desired to provide a frame with built-in features allowing for a passage between the walls of the compactor and shelves therein. It is also desired to provide a strong, lightweight, low-cost, cabinet which is easy to assemble.

### SUMMARY OF THE INVENTION

The cabinet is made from two pieces of sheet metal which are shaped to provide a front portion, a side wall and half the back wall of the cabinet. The front of the cabinet has a small front facing surface for attaching doors for access to the cabinet. The back wall has a V-shaped indentation for allowing a passage between the back wall and a shelf in the cabinet and to give the back wall added strength. The back wall also has a V-shaped overlap portion which connects the two halves of the cabinet and adds strength to the cabinet. Shelves and supports are attached to the walls in the cabinet which provide strength for the cabinet and support the mechanisms for compacting trash. A base and a cover attached to the two sheet metal pieces complete the construction of the trash compactor cabinet.

The sheet metal walls of the cabinet are bent into the desired shape and are lightweight, inexpensive and strong. V-Shaped indentations add strength to the back wall and allow a passageway between the back wall and shelves inside the trash compactor. The front portion of the sheet metal wall is bent to form a channel with a front facing portion for attaching doors, door frames or walls. The channel also adds strength to the cabinet. An overlapping V-shaped portion in the rear wall allows the two wall sections to be connected by welding or otherwise fastening the two wall sections together and the V shape provides strength for the cabinet.

### OBJECTS OF THE INVENTION

It is an object of the invention to provide a low-cost, easy to make cabinet for a trash compactor.

It is an object of the invention to provide a strong, lightweight cabinet for a trash compactor.

It is an object of the invention to provide a passageway between the shelves and the back wall of the trash compactor.

It is an object of the invention to provide an easy to assemble cabinet for a trash compactor.

Other objects, advantages and novel features of the present invention will become apparent from the following description of the preferred embodiments when considered in conjunction with the accompanying drawings.

### BRIEF DESCRIPTION OF THE DRAWINGS

FIG. 1 is a perspective view of the trash compactor walls assembled and shelves installed.

FIG. 2 is a top view of one panel of the cabinet walls.

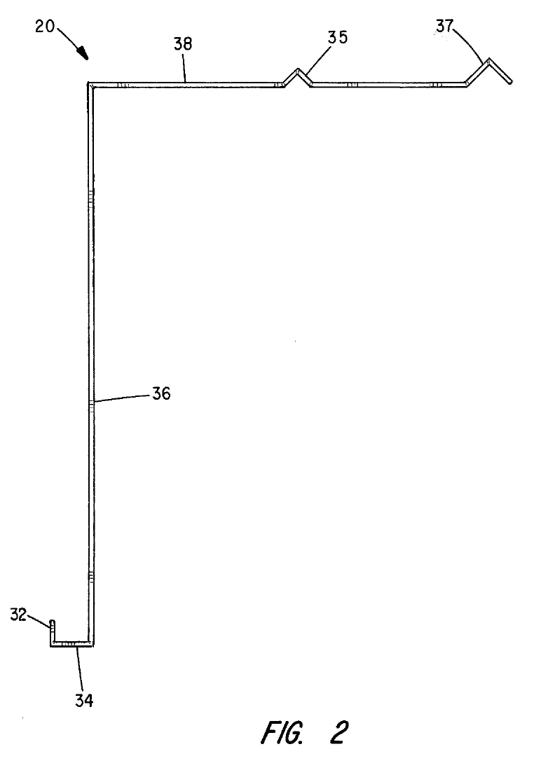

FIG. 3 is front view of one panel of the cabinet walls.

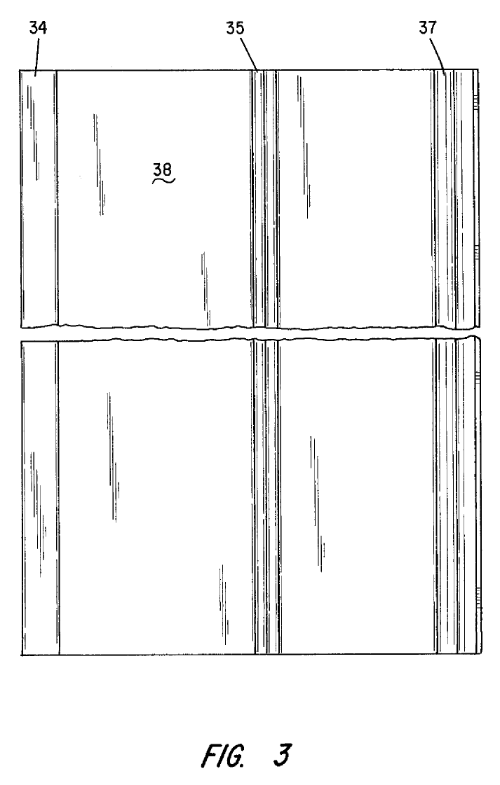

FIG. 4 is a back view of one panel of the cabinet walls.

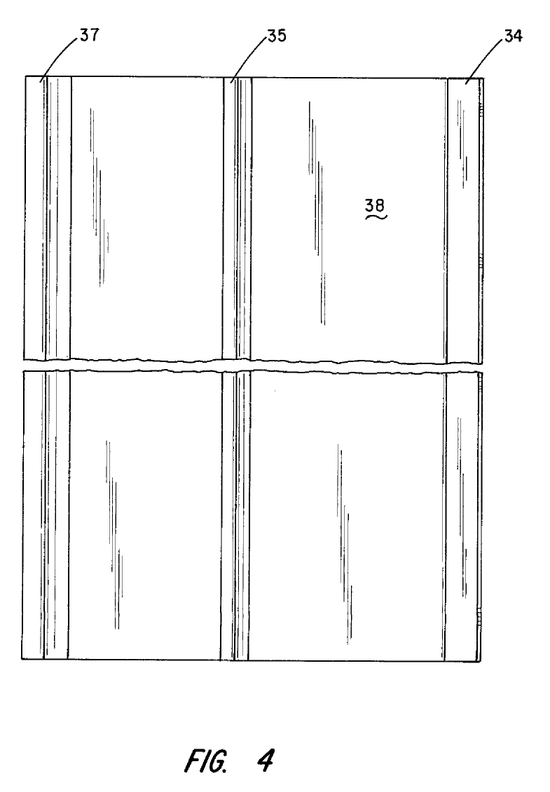

FIG. 5 is a right side view of one panel of the cabinet walls.

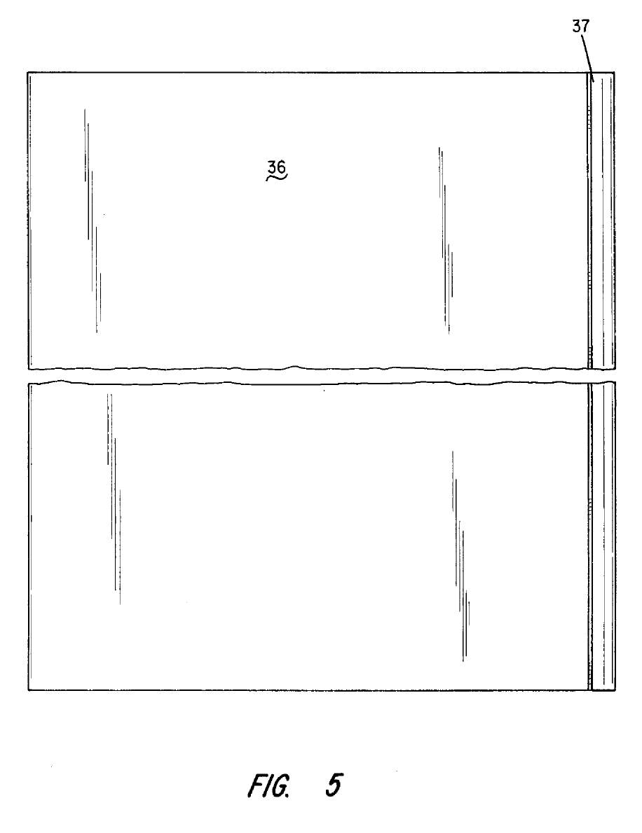

FIG. 6 is a left side view of one panel of the cabinet walls.

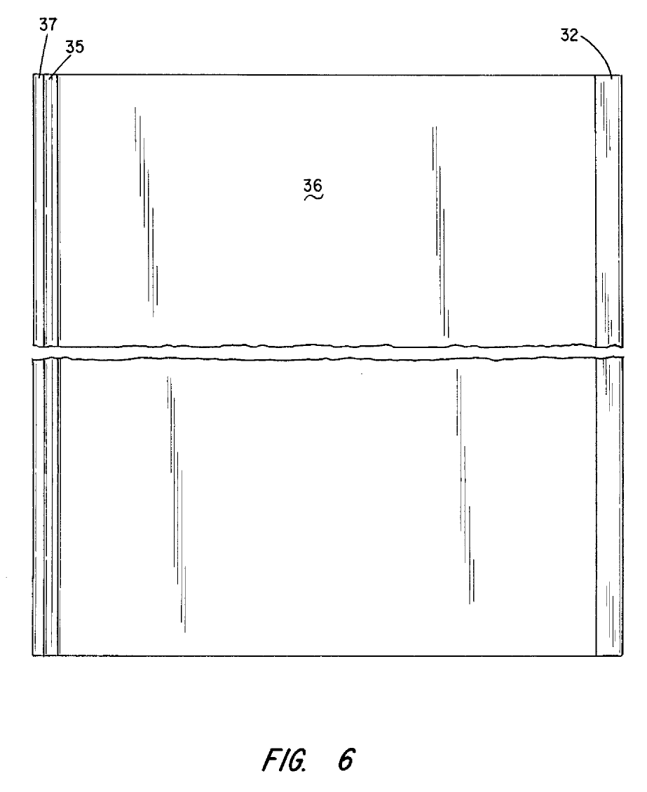

FIG. 7 is a perspective view of two panels of the compactor walls assembled.

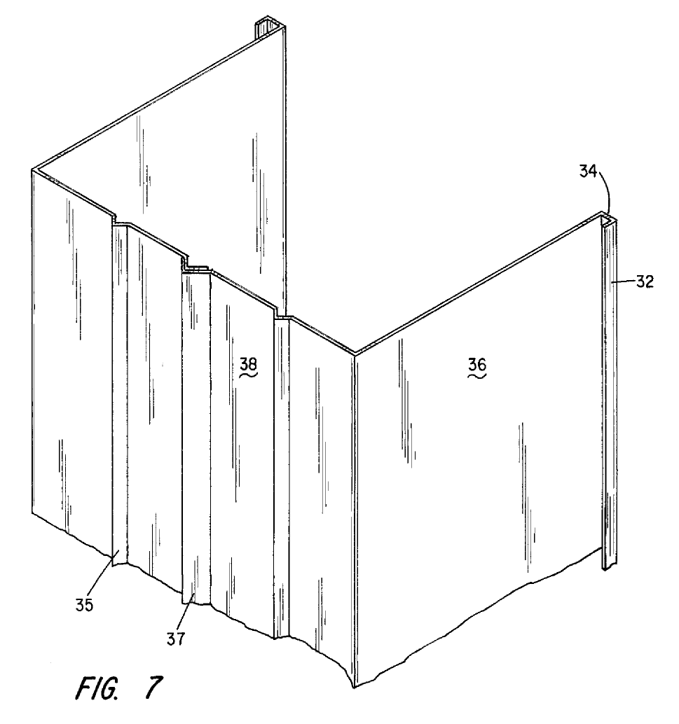

### DESCRIPTION OF THE PREFERRED EMBODIMENTS

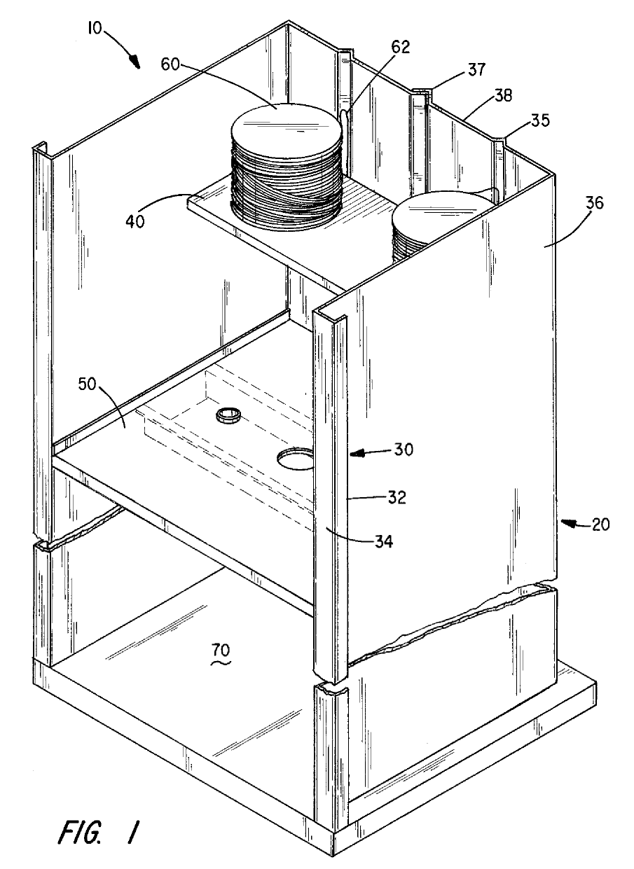

A trash compactor cabinet 10 is shown in FIG. 1. It has two panels 20 which are formed from sheet metal. The panels 20 are formed by bending the sheets to form a channel 30 at one end, having a side portion 32, a front facing portion 34 and a side wall 36. Panel 20 also has a back wall 38 with a first V-shaped channel 35 approximately in the middle of the back wall 38 and a V-shaped channel 37 at the other end of the panel 20. The bends in the panel 20 are easily made with a brake to bend the sheet metal to the desired shape. The panels 20 are the same on both halves of the trash compactor cabinet 10. When assembled, one panel 20 is inverted and attached to the other panel 20 at overlapping nesting channels 37. The attachment may be by welding, spot welding or by use of fasteners or adhesives for bonding the two halves together in channel 37.

After the panels 20 are assembled, shelves 40 and 50 may be attached. The shelves 40, 50 will help provide rigidity to the cabinet 10. In the embodiment shown in FIG. 1, the top shelf 40 has spools of string or twine 62 for bundling compacted trash. The twine 62 can be threaded between the shelves 40, 50 and the back wall 38 by passing through V-shaped channel 35.

A base 70 is shown in FIG. 1. The doors, door frames and top are not shown in this figure but it is well understood in the industry that sides, tops and fronts, including doors and door frames, are attached to trash compactor cabinets. The applicant's compactor U.S. Pat. Nos. 5,012,732 issued May 7, 1991 and 7,237,477 issued Jul. 3, 2007 are attached hereto and incorporated herein by reference to show trash compactors in general with various doors, door hinges, tops, bottoms, compaction mechanisms, and wheels under the trash compactors.

Although the channels 35, 37 have been shown as V-shaped channels, any shape channel may be used, such as square, round or any polygon.

Obviously, many modifications and variations of the present invention are possible in light of the above teachings. It is therefore to be understood that, within the scope of the appended claims, the invention may be practiced otherwise than as specifically described.

1. A trash compactor cabinet comprising:
two panels, each panel having a rectangular channel at one end,
a side wall extending from the channel to,
a rear wall, the rear wall having a channel approximately in the middle of the rear wall and a V-shaped channel at the other end of the panel,
the panels overlapping and nesting in the V-shaped channels and fastened to each other along the overlapping channels.

2. A trash compactor cabinet as in claim 1 having,
a shelf attached to the side walls and the rear wall of the cabinet with a gap between the rear wall and the channel forming a passageway between the shelf and the rear wall.

3. A trash compactor cabinet as in claim 1 having,
a base for supporting the pane.

4. A trash compactor cabinet as in claim 2 having,
a base attached to the panels for supporting the cabinet.

5. A trash compactor cabinet as in claim 4 having,
a top attached to the panels.
